(19) United States
(12) Patent Application Publication
(10) Pub. No.: US 2026/0295954 A1
(43) Pub. Date: Oct. 1, 2026

(54) SOLUTIONS AND METHODS FOR REMOVING UNWANTED MATERIAL FROM ADDITIVE MANUFACTURED OBJECTS HAVING ELASTOMERIC PROPERTIES

(71) Applicant: PostProcess Technologies, Inc., Buffalo, NY (US)

(72) Inventors: Matthew J. Noble, Buffalo, NY (US); Steven Russell, Buffalo, NY (US)

(21) Appl. No.: 19/477,721

(22) PCT Filed: May 13, 2024
(86) PCT No.: PCT/US2024/029148

§ 371 Date: Oct. 22, 2025

Related U.S. Application Data
(60) Provisional application No. 63/469,604, filed on May 30, 2023.

(51) Int. Cl. B29C 71/00; B33Y 40/20

(52) U.S. Cl. CPC B29C 71/0009; B33Y 40/20; B29C 2071/0027; B29C 2071/0045; B29K 2995/0046

(57) ABSTRACT

The disclosure relates to compositions or cleaning solutions configured to remove unwanted materials from an (e.g., additive manufactured) object, while retaining an underlying elastomeric property of the object. The disclosure also relates to methods of using such compositions or cleaning solutions to remove unwanted material from an (e.g., additive manufactured) object while retaining the elastomeric property of the object.

### FIELD

The following disclosure relates to compositions or solutions for removing unwanted materials such as uncured resins or waxes, e.g., from additive manufactured compositions or objects that have elastomeric properties. The disclosure also relates to methods of using such compositions or solutions to remove unwanted material from the surface of an additive manufactured object without adversely affecting the elastomeric properties of the object.

### BACKGROUND

Additive manufacturing processes, such as three-dimensional (3D) printing, are processes by which a computer-controlled device (e.g., printer) creates an object by sequentially applying material. That is, an object is “printed,” e.g., using a printer that additively deposits material in such a way that the object is created (printed) from a starting platform (a “printing tray” or a “build tray”). Additive manufacturing processes may provide significant advantages for many applications. For example, the additive manufacturing process may be used for the production of parts having complex geometries that would be difficult to make using traditional manufacturing techniques. Also, additive manufacturing processes may provide a solution for the efficient production of low volumes of parts.

Non-limiting examples of additive manufacturing processes include Selective Laser Sintering (SLS), Stereolithography (SLA), Digital Light Printing (DLP), fused deposition modeling (FDM), and material jetting (MJ) such as PolyJet, electron beam (e-beam).

Some additive manufacturing processes, however, produce parts that require removal of unwanted material, such as uncured or cured support material. The unwanted material is produced during the printing portion of the additive manufacturing process and may be needed to support portions of the part as the part is being printed. After the printing portion of the process is completed, the unwanted material must be removed before the part can be used for its intended purpose.

The unwanted material itself may have a complex geometry and may also be extensive because it may support the object at a plurality of locations. Additionally, because additive manufacturing prints an object in discrete layers, the surface finish of an object may be rough because edges of the layers may not align precisely with each other, thus creating a rough, bumpy outer surface. This outer surface may be unappealing visually or may have stress concentrations or irregularities, which need to be removed before testing or use.

Some solutions for additive manufactured objects, while valuable in cleaning and removing the unwanted material from the surface of the object, may adversely affect the elastomeric properties of the additive manufactured object. In other words, the removal of unwanted material, such as uncured resin and or wax support, from additive manufactured build materials having elastomeric properties poses a significant challenge as many commercial cleaning solutions or solvents may change or damage their elastomeric properties. For example, poor chemical compatibility may be present between elastomeric materials, such as o-rings, and various components of commercial cleaning solutions.

In some cases, this reduction or destruction of the elastomeric property of the object may be undesirable for the end product's use. Specifically, many commercial solvents that would be ideal for resin and/or wax removal may not work or be compatible with the elastomeric materials being cleaned, therein causing the elastomeric part to swell up to many times their normal size, damage the part's' elasticity, or soften parts to the point of dissolving. This creates a challenging problem with chemical removal of the resin or wax left on elastomeric parts and finding a solution that targets the support materials, while not affecting or minimizing changes to the build materials properties. As such, there remains a need for a composition or solution capable of removing unwanted material from an additive manufactured object without adversely affecting or destroying the elastomeric properties of the object.

### SUMMARY

The disclosure provides compositions or cleaning solutions and methods for removing support material from an additive manufactured object.

In one embodiment, a solution for an additive manufactured object is provided. The solution includes at least one aliphatic alcohol and/or at least one polyol or glycol. Further, the cleaning solution is configured to remove a support material from the additive manufactured object while retaining an elastomeric property of an underlying build material of the additive manufactured object.

In another embodiment, a method of removing unwanted material from an object having elastomeric properties is provided. The method includes: providing the object having a build material and the unwanted support material; providing a cleaning solution having at least one aliphatic alcohol and/or at least one polyol or glycol; submerging the object in the cleaning solution; and removing the object from the cleaning solution, wherein at least a portion of the unwanted support material has been dissolved in the cleaning solution, and wherein the elastomeric property of the build material of the additive manufactured object has been retained following the removing of the object from the cleaning solution.

In another embodiment, a cleaned object is formed by a process of: submerging, in a cleaning solution, an object having a build material and the unwanted support material, wherein the object further includes an elastomeric property; and removing the object from the cleaning solution, wherein the unwanted support material has been removed from the object and remains within the cleaning solution, therein forming the cleaned object having the build material, wherein the cleaned object retains the elastomeric property of the object, and wherein the cleaning solution includes at least one aliphatic alcohol and/or at least one polyol or glycol.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts a flow diagram of an exemplary method of using a cleaning solution.

FIG. 2A depicts an example of a machine configured to be used to finish a 3D-printed object with a cleaning solution.

FIG. 2B is a cross-sectional view of the machine depicted in FIG. 2A.

While the disclosed compositions and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

Improved compositions or solutions and methods for using the solutions in the removing of unwanted material from additive manufactured objects are disclosed herein.

Although the disclosure will be described in terms of certain embodiments, other embodiments, including embodiments that do not provide all of the benefits and features set forth herein, are also within the scope of this disclosure. Various structural, logical, and process step changes may be made without departing from the scope of the disclosure.

The disclosure may be embodied as one or more compositions or solutions configured to remove unwanted material from additive manufactured polymers, resins, plastic materials, or parts (e.g., a 3D printed object). In particular, the disclosure relates to a solution configured to remove unwanted material (e.g., uncured resin or wax from a 3D printed object).

### Definitions

As used herein, the term “object” may refer to an additive manufactured or 3D-printed object that may not be in its desired final form.

As used herein, the term “elastomeric” or “elastomer” may refer to a physical property of a material or object or the material/object itself that is capable of regaining its original shape after being distorted (e.g., stretched, bent, twisted). Molecules of elastomers are held together by weak intermolecular forces and may exhibit low Young's modulus, high yield strength, high failure strain, and/or high percent elongation before breaking. As such, in addition to having flexible properties of being able to bend easily without breaking, elastomers have the ability or property of regaining their original shape and size after being significantly stretched, flexed, or deformed.

As used herein, the term “cleaning” may refer to removing unwanted material from the surface of an additive manufactured object (e.g., a 3D-printed object). Cleaning may include one or more processes, including, but not limited to, removing unwanted material such as uncured material, resin, wax, metal powder, print material, and/or support material.

As used herein, the term “unwanted material” may include unwanted support material (e.g., on a surface of a 3D printed object), unwanted uncured material, unwanted resin, and/or unwanted wax. Unwanted material may be the same material as the object being manufactured (i.e., the build material) or may be a different material. In some examples, unwanted material may refer to an uncured resin or wax material present on a surface of the additive manufactured or 3D-printed object.

As used herein, the term “agitated” may refer to effecting movement by an outside force. With regard to the cleaning solution, non-limiting examples of agitation include moving the cleaning solution via a pump, stirring, using longitudinal waves at an ultrasonic frequency, spraying, or combinations thereof.

As used herein, the term “resin” may refer to any solid or highly viscous substance, e.g., of synthetic origin that may be convertible into a polymer. In certain examples, a resin may include a mixture of organic compounds. In certain examples, a resin may refer to an acrylate or acrylic polymer composition that may be used in 3D printing or additive manufacturing processes. Such compositions may contain multiple polymers configured to target certain properties for the subsequently cured 3D printed part. The resin may include or be mixed with a photo initiator that is configured to cause a polymerization reaction when exposed to ultraviolet light. In some examples, the resin may be a thermoplastic composition that may advantageously be repeatedly heated and shaped.

As used herein, the term “wax” may refer to organic or natural compounds (natural waxes) as well as synthetically manufactured compounds (synthetic waxes) having similar properties to the natural wax compounds. Non-limiting examples of natural waxes include compounds having long aliphatic alkyl chains and/or aromatic compounds such as paraffin (or petroleum) waxes having 20 to 40 carbon atoms. Such compounds are solid at room temperature (e.g., 20-25° C.) and begin to melt at temperatures above 37° C. Synthetic waxes may include polymers such as polyethylene wax derived from ethylene. These natural and synthetic wax compounds may advantageously be used in the 3D printing process.

### Additive Manufacturing of Elastomeric Objects

In additive manufacturing processes, additional material (“support material”) may be printed for the purpose of supporting portions of the object or mold (i.e., the “build material”) during printing of the object or mold. The support material advantageously buttresses the object or build material to prevent issues like sagging. The support material may have a complex geometry and may also be extensive because it may support the object at a plurality of locations.

The support material may be the same as or a different material from the build material. In certain examples, the build material may have a first composition and the support material may have a second, different composition that may be configured to be removed from the build material through a post process cleaning.

To remove support material from the build material, and to remove other unwanted material in the 3D printing process, chemicals may be applied to the 3D printed object. These chemicals may be in the form of a liquid solution. Some solutions for additive manufactured objects, while valuable in cleaning and removing the unwanted material from the surface of the object, may be hazardous to work with, have a low flash point, or provide an environmental challenge in the recycling or discarding of the spent cleaning solution. One example of a commercial cleaning solution is or contains isopropanol (IPA), which has a low flash point, so that it may be hazardous to work with. As such, improved cleaning solutions are disclosed in greater detail below that remove unwanted material from the 3D printed object more effectively without affecting the elastomeric properties of the underlying build material. These solutions also advantageously may be used under safer operating conditions and at a reduced cost over commercial solutions like IPA.

### Compositions or Cleaning Solutions

Compositions or cleaning solutions for improving the removal of unwanted support material without adversely affecting properties (e.g., elastomeric properties) of the underlying build material are disclosed herein. In other words, such cleaning solutions disclosed herein may be configured to successfully clean elastomeric 3D printed objects by removing resins and/or waxes from a surface of the printed object, while producing minimal to no observable swelling in the printed object.

As discussed below, the solution may include one or more of the following components: (a) at least one aliphatic alcohol; (b) at least one polyol or glycol; (c) at least one long chain ester; (d) at least one plasticizer; (e) at least one emulsifier; and/or (f) at least one glycol ether acetate. These components, e.g., in combination with one another in certain formulations, may advantageously function as an effective cleaning solution while avoiding damaging or reducing elastomeric properties of the additive manufactured object.

### Aliphatic Alcohol

In certain examples, the cleaning solution may include at least one (e.g., aliphatic) alcohol. Alcohols, such as aliphatic alcohols, may be advantageous in dissolving wax-based compositions as well as some resin compositions on a surface of the additive manufactured object, while also avoiding adversely affecting elastomeric properties of the object.

The at least one alcohol may include an aliphatic straight chain and/or an aliphatic branched chain alcohol. In some examples, the aliphatic alcohol is an aliphatic mono-hydroxy alcohol having only one hydroxyl group. In certain examples, the aliphatic alcohol is a long chain aliphatic alcohol. As used herein, a long chain may refer to a compound having a carbon chain with four or more carbon atoms in the chain.

Nonlimiting examples of such aliphatic alcohols include: 1-Pentanol, 1-Hexanol, 1-Heptanol, 2-Heptanol, 1-Octanol, 2-Octanol, 3-Octanol, 1-Nonanol, 1-Decanol, 2-Denanol, 3-Decanol, 1-Undecanol, 2-Undecanol, or combinations thereof.

In other examples, the alcohol may be an aromatic or aryl-alcohol having a hydroxyl group indirectly bonded to an aromatic hydrocarbon. One such nonlimiting example of an aromatic or aryl-alcohol is benzyl alcohol.

### Polyols/Glycol

In certain examples, the cleaning solution may include at least one polyol or glycol, such as a diol or triol. These polyols or glycols are advantageous in having a higher flash point than commercial cleaning solutions such as isopropyl alcohol (IPA). In other words, the addition of a polyol/glycol to the cleaning solution composition may improve or increase the overall flash point of the solution. In certain examples, the flash point of the solution having at least one polyol or glycol is greater than at least 65.6° C. (150° F.), at least 71.1° C. (160° F.), at least 76.7° C. (170° F.), at least 82.2° C. (180° F.), at least 87.8° C. (190° F.), or at least 93.3° C. (200° F.). This may provide a safer working environment with less costly processing equipment based on the flash point of the overall solution having the polyol or glycol composition.

In addition to improving/increasing the flash point, therein providing a safer working environment, polyols or glycols may also be advantageously environmentally friendly. Further, the polyol or glycol composition may improve the odor of the cleaning solution.

In certain examples, the polyol or glycol is an aliphatic diol (compound containing two hydroxyl groups (—OH groups)) and or aliphatic triol (compounds containing three hydroxyl groups (—OH groups)). Nonlimiting examples of such aliphatic diols or aliphatic triols include 2-Ethyl-1-Hexanol, 2-Ethyl-1,3-Hexanediol (also known as Etohexadiol), Propylene Glycol, Dipropylene Glycol, 1,3-Propanediol, 2-Methyl-2,4-pentanediol (also known as Hexylene Glycol), 1,4-Butanediol, 2,2-dimethylpropane-1,3-diol (also known as Neopentyl Glycol), 2-Methyl-1,3-propanediol, 1,4-Butanediol, 1,5-Pentanediol, 1,6-Hexanediol, 1,10-Decanediol, or combinations thereof.

### Long Chain Ester

In certain examples, the cleaning solution may include at least one long chain ester. Again, as used herein, a long chain may refer to a compound having a carbon chain with four or more carbon atoms in the chain.

The addition of a long chain ester may advantageously remove unwanted resins or wax compositions from the surface of an additive manufactured object. Further, long chain esters may advantageously have higher flash points than commercial cleaning solutions such as isopropyl alcohol (IPA). In other words, the addition of a long chain ester to the cleaning solution composition may improve or increase the overall flash point of the solution. In certain examples, the flash point of the solution having a long chain ester may be greater than at least 65.6° C. (150° F.), at least 71.1° C. (160° F.), at least 76.7° C. (170° F.), at least 82.2° C. (180° F.), at least 87.8° C. (190° F.), or at least 93.3° C. (200° F.). As noted above, this may provide a safer working environment with less costly processing equipment based on the flash point of the overall solution having the polyol or glycol composition.

Nonlimiting examples of high flash point esters include Isoamyl Laurate, Isopropyl Myristate, Isopropyl Palmitate, Triacontyl Palmitate, Hexyl Butyrate, Heptyl Butyrate, Ethyl Benzoate, Propyl Benzoate, Butyl Benzoate, Butyl 3-hydroxybutonoate, or combinations thereof.

### Plasticizer

In certain examples, the cleaning solution may include at least one plasticizer composition. Plasticizers within the elastomeric material may advantageously improve (increase) such properties as flexibility, pliability, durability, longevity, biodegradability, and/or extensibility in polymers. Plasticizers may affect the properties of a material or product without fundamentally changing the material's basic chemical makeup. Plasticizers may also advantageously help improve a product's elastic modulus upon completion. By modifying the type or amount of plasticizer, properties may be tailored to meet requirements like high tensile strength or even soften the material.

In other words, plasticizers may advantageously improve the performance of the cleaning solution with regards to retaining the elastomeric properties of the additive manufactured object. Specifically, due to a plasticizer's ability to make a material softer or more flexible or decrease a material's brittleness, a cleaning solution having such a composition may advantageously protect or maintain the elastomeric properties of the object being cleaned.

Elastomeric 3D printed objects may lose their elasticity because their internal elastomeric materials or plasticizers within the 3D printed object may be removed or replaced by one of the cleaning chemicals during the cleaning process. Therefore, the addition of a plasticizer to the cleaning solution formulation may prevent elastomeric properties within the 3D printed object from being changed or damaged by undesirable properties of other components/chemicals present in a cleaning solution.

Nonlimiting examples of such plasticizer compositions include Dioctyl Terephthalate, Diethyl Phthalate, Dibutyl Phthalate, Diisobutyl Phthalate, Bis (2-ethylhexyl) Terephthalate, Diisobutyl Terephthalate, Propylene Glycol Dibenzoate, Diethylene Glycol Dibenzoate, Dipropylene Glycol Dibenzoate, or combinations thereof.

### Emulsifier

In certain examples, the cleaning solution may include at least one emulsifier. An emulsifier may advantageously be included within the cleaning solution to make the cleaning solution homogenous.

Nonlimiting examples of emulsifiers include water-soluble non-ionic triblock copolymers, known as Poloxamers, formed by polar (polyethylene oxide) and non-polar (polypropylene oxide) blocks (PEO-PPO-PEO) that confer amphiphilic and surface active properties to the polymers. Examples of such Poloxamers, also known as Pluronics®, may have a molecular weight in a range of 1000 to 3000, a PEO content <20, and an HLB in a range of 1 to 10. In certain examples, the Poloxamer is Poloxamer 181, also known as Pluronic L61.

### Glycol Ether Acetate

In certain examples, the cleaning solution may include at least one glycol ether acetate. A glycol ether acetate may advantageously improve the dissolution of an unwanted material (e.g., resin or wax) from the surface of the 3D printed object.

Nonlimiting examples of glycol ether acetates include 2-Butoxy Ethanol Acetate, Dipropyl Glycol Monomethyl Ether Acetate, Methyl Carbitol Acetate, Ethyl Carbitol Acetate, Butyl Carbitol Acetate, Propyl Carbitol Acetate, Dipropylene Glycol Butyl Ether Acetate, or combinations thereof.

### Cleaning Solutions by Weight %

In certain examples, such a cleaning solution may include: (a) 1-100% by weight of at least one aliphatic alcohol and/or at least one polyol or glycol, and (b) 0-99% by weight of one or more additional components as described above (e.g., at least one long chain ester, at least one plasticizer, at least one emulsifier, and/or at least one glycol ether acetate), such that the total weight percent of the aliphatic alcohol and/or polyol/glycol and the one or more additional components add up to 100% (i.e., wherein the total weight percent of these components ignores any further additives or impurities present in the cleaning solution).

In one example, part (a) of the cleaning solution may include 0-100% by weight of at least one aliphatic alcohol and 0-100% by weight of at least one polyol/glycol (wherein the total weight percent of these components add up to 100% of part (a) of the cleaning solution). In another example, part (a) of the cleaning solution includes 0-50% by weight of an aliphatic alcohol and 50-100% by weight of a polyol/glycol. In another example, part (a) of the cleaning solution includes 50-100% by weight of an aliphatic alcohol and 0-50% by weight of a polyol/glycol. In another example, the solvent in the cleaning solution includes 25-75% by weight of an aliphatic alcohol and 25-75% by weight of a polyol/glycol.

In another example, the cleaning solution may include: (a) 1-50% by weight of at least one aliphatic alcohol, (b) 1-50% by weight of at least one polyol/glycol, (c) 1-50% by weight of at least one long chain ester, (d) 1-50% by weight of at least one plasticizer, (e) 0.1-10% by weight of at least one emulsifier, and (f) 1-20% by weight of at least one glycol ether acetate, such that the total weight percent of these components adds up to 100% (i.e., wherein the total weight percent of these components ignores any further additives or impurities present in the cleaning solution).

### Performance Properties

In certain examples, the cleaning solution may be configured to remove at least 50%, at least 60%, at least 70%, at least 80%, at least 90%, at least 95%, at least 99%, or 100% of the unwanted support material (e.g., uncured resin or support wax) from the surface of the build material of the additive manufactured object.

In certain examples, the cleaning solution may be configured to remove the above-described percentage of support material while removing less than 10%, less than 5%, less than 1%, or 0% of the underlying build material of the additive manufactured object.

In further examples, the cleaning solution may be configured to remove the unwanted support material while retaining the underlying build material and the elastomeric properties of the underlying build material.

The elastomeric properties of the additive manufactured object may be defined by one or more mechanical tests or observations to the object pre-cleaning (pre-removal of the unwanted support material) and/or post-cleaning (following removal of the unwanted support material). In one example, the mechanical test may be a rubber tensile test (see, e.g., ASTM D412). In another example, the test may be an elastomer tear test (see, e.g., ASTM D624). In other examples, the test may be a compression set under constant deflection test (see, e.g., ASTM D395). In yet other examples, the testing may include a swelling test to identify the 3D printed object's ability to withstand the effect of exposure to a liquid. In some examples, this swelling test may be conducted via ASTM D471 test method.

In some examples, one or more of the above-referenced tests conducted on an additive manufactured object may demonstrate that the properties of the object following the cleaning process/exposure to the cleaning solution have retained the elastomeric properties of the object. In certain examples, the elastomeric properties of the object following cleaning/removal of unwanted material are at least 90%, at least 95%, at least 99%, or 100% of the elastomeric properties of the object pre-cleaning. That is, in one case, the tensile test of the post-cleaned object is at least 90%, at least 95%, at least 99%, or 100% of the value of the tensile test of the pre-cleaned object.

### Methods of Use

In certain methods of use of the cleaning solutions disclosed herein, an additive manufactured object (e.g., 3D-printed object) may be subjected to a process to remove unwanted material (e.g., uncured resins or waxes), and thereby provide a cleaned object.

In one such method, the object is placed in a tank that has been filled (e.g., filled at least partially) with a liquid cleaning solution as described above. The object may be submerged in the cleaning solution.

While the object is in the cleaning solution (e.g., submerged in the cleaning solution), the object may be subjected to application of mechanical energy, such as agitation, abrasion, and/or heating in order to remove the unwanted support material from the object. Mechanical energy agitation may occur by moving the liquid cleaning solution (e.g., via a pump) and/or by using ultrasound.

In an alternative process, the object is subjected to a liquid spray. In such a process, the object is placed in a chamber, and a pump is used to force the liquid cleaning solution through one or more nozzles (e.g., spraying), which apply the cleaning solution to the object and mechanically agitate the object.

In both submersion and spraying processes, the liquid may include chemical solvents (e.g., glycol ethers or glycol ether acetates discussed above) to dissolve unwanted material, and thereby create a cleaned form of the object. Heat from an apparatus or heating system may be used to maintain the cleaning solution at a desired temperature. Under these conditions, the unwanted material may be removed thermally, chemically, mechanically or via a combination of two or more of these methods.

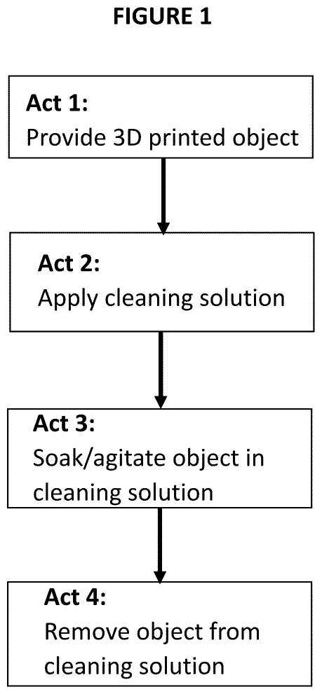

FIG. 1 depicts a flow diagram of an exemplary method of such a process. The steps of such a method may be sufficient to remove unwanted support material from the surface of the object.

In act 1, a 3D printed object is provided or made from a resin or wax-based printing composition. The object may include an elastomer, or the object may have elastomeric properties.

In act 2, a cleaning solution may be applied to the 3D printed object or a portion thereof. Application of the cleaning solution may be accomplished by submerging in the cleaning solution all or part of the object that requires cleaning for removal of the unwanted support material. When used herein, the word “submerged” refers to a situation where the object is submerged at a depth sufficient to cover the object or portion thereof that requires cleaning. The cleaning solution may be stored in a holding vessel/container/tank. Non-limiting examples of materials that the holding vessel/container/tank may be made of include stainless steel, glass, high density polyethylene, Teflon, Kalrez, Polyvinylidene Fluoride (PVDF), and the like.

The cleaning solution may be heated to or maintained at a temperature to increase the rate of solubilization of unwanted support material. In certain examples, the cleaning solution may be heated above ambient temperature conditions (e.g., 20° C. or 68° C.) to an elevated temperature that increases the rate of solubilization of the unwanted support material but remains less than a temperature that may adversely affect the wax-based build material (e.g., wherein the wax-based build material begins to melt). For example, the cleaning solution may be kept at an elevated temperature above ambient temperature up to 37° C. (98.6° F.) (including all 0.1° C. or 0.1° F. values and ranges between 20° C. (68° F.) and 37° C. (98.6° F.)), before the object is submerged and/or while the object is submerged.

In act 3, the object may be soaked and/or agitated within the cleaning solution during at least part of the application. Agitation and/or vibration may be induced by methods such as, but are not limited to, sonication (e.g., via an ultrasonic transducer sending ultrasonic longitudinal waves into the cleaning solution), a pump (e.g., using a pump to effect fluid movement), stirring, spraying, or a combination thereof. An example of such equipment is disclosed in FIGS. 4A and 4B, discussed in greater detail below.

Stirring of the cleaning solution may be performed by the use of an impeller, mechanical stirrer, stir bar, or the like. The cleaning solution may be agitated for an appropriate time period necessary for the support material to be removed within the solution. In certain examples, this time period of agitation within the solution may be within a range of 0-60 minutes, including all 1 second values and ranges therebetween (e.g., 1-60 minutes, 10-30 minutes, 1-15 minutes, 15-30 minutes, 30-60 minutes, etc.).

In certain examples, the extent or level of agitation may be controlled to avoid damage to the wax-based build material. In other words, while a certain degree of agitation may be helpful in removing the unwanted support material within the cleaning solution, too much agitation may potentially damage the underlying wax-based build material. The level of agitation may be controlled by limiting the speed or frequency of the stirring or oscillation within the solution. Additionally, or alternatively, the level of agitation may be controlled by positioning the 3D printed object within a mesh basket such that the basket material impedes the flow of the cleaning solution around the object during agitation of the basket and object within the cleaning solution.

Sonication may be performed at a power up to and including 1750 W, including all 0.1 W values and ranges below 1750 W, where power may vary temporally, and at a frequency of 20-100 kHz, including all 0.1 kHz values and ranges therebetween. In a preferred example, the frequency is 40 kHz. Sonicating a cleaning solution may agitate the cleaning solution such that the cleaning solution does not separate into distinct phases and/or such that a force is applied to the object, or to move the cleaning solution. Applying a force to the object helps dislodge and/or dissolve unwanted material. Such a cleaning solution may be agitated for 0-60 minutes, including all 1 second values and ranges therebetween (e.g., 1-60 minutes, 10-30 minutes, 1-15 minutes, 15-30 minutes, 30-60 minutes, etc.), prior to the object being submerged, and/or while the object is submerged.

The ultrasonic waves may be provided at a selected first agitation frequency. When agitated by the first frequency, the amplitude of the reflected ultrasonic waves may be detected by a sensor, and the amplitude of the reflected waves may be measured. Based on the measured amplitude, a second ultrasonic frequency may be selected, for example, using a database. Then ultrasound waves having the selected second ultrasonic frequency may be directed at the object. In this manner, the second ultrasonic frequency may be selected so as to optimally agitate.

When the desired run time has been reached, the object may be removed from the cleaning solution/tank and (e.g., visually) inspected to determine whether additional run-time is needed. In some examples, the wax-based build material and the wax-based support material have different colors. In such a case, upon removal from the cleaning solution, the cleaned object may be visually inspected to see if any remaining support material is present based on the known color of the support material.

In act 4, the object is removed from the cleaning solution to provide a cleaned object. The cleaned object may be subsequently rinsed, dried, and/or scrubbed to remove any further support material from the surface of the object.

Various cleaning machines may be used for certain methods described herein with the cleaning solutions disclosed herein to clean a 3D-printed object.

In certain examples, the cleaning machine may be similar or identical to a machine disclosed in U.S. Pat. No. 10,737,440, the entire disclosure of which is incorporated herein by reference. In an alternative example, the cleaning machine may be similar or identical to any DEMI™ model machine by PostProcess Technologies, Inc. Nonetheless, the cleaning solutions disclosed herein are not necessarily intended to be limited for use only in these specific machines.

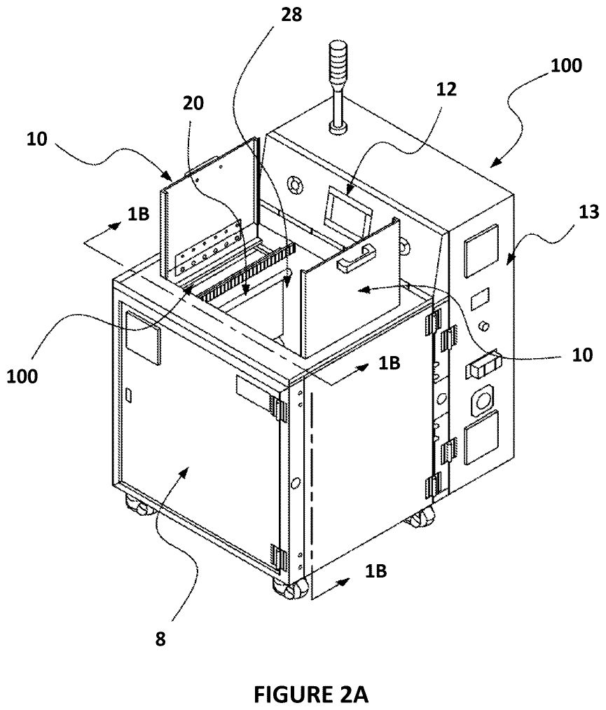

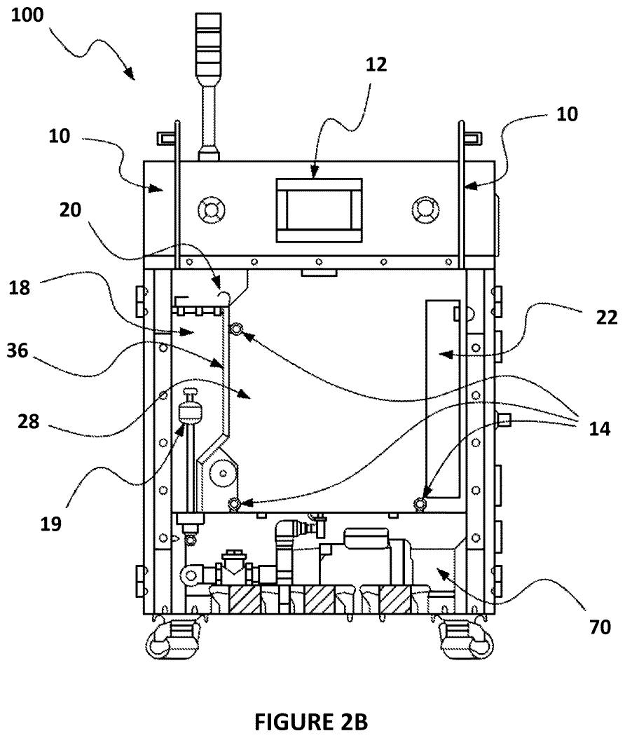

In one particular example, FIG. 2A depicts a machine configured to be used for certain methods described herein with the cleaning solutions described herein to clean a 3D-printed object. FIG. 2B is a cross-sectional view of the machine depicted in FIG. 2A.

FIGS. 2A and 2B depict a cleaning machine 100, a control panel 12, cover doors 10, a front panel 8, a tank 28 configured to hold a cleaning solution (as described herein), a weir 20, a computer 13, an input tank 18, a liquid level sensor 19, a wall 36, an ultrasonic generator 70, a tank manifold 14, and ultrasonic transducers 22.

The cleaning machine 100 may be used in a method to clean a 3D-printed object by: (a) adding a cleaning solution into a tank 28 of a machine (e.g., a machine 100 used for cleaning a 3D printed object); (b) using a heater that is arranged in the tank 28 to heat the cleaning solution to a desired temperature; (c) using a pump to move the cleaning solution within the tank; (d) using an ultrasonic transducer 22 arranged relative to the tank to provide ultrasonic longitudinal waves and/or cavitation within the tank that agitate the cleaning solution; and (e) contacting an object with the cleaning solution for a desired time to remove unwanted material from the object.

Additional agitation, such as from a pump, may reduce the amount of time needed to remove unwanted material from the surface of the object. Using such a machine may involve: (a) adding a cleaning solution into a machine 100 from the top of the machine by lifting a lid (or other suitable mechanism to cover the tank 28, such as the cover doors 10 depicted in FIG. 2A and FIG. 2B) and pouring the cleaning solution directly into a tank 28; (b) mixing the cleaning solution (e.g., mixing may be performed by a pump and/or ultrasonic agitation) sufficiently so that the cleaning solution does not separate; (c) heating the cleaning solution via a submerged heater arranged in the tank, in order to heat the cleaning solution to a desired temperature; and (d) pumping the cleaning solution using a pump that may be arranged below the tank, in order to move the cleaning solution through the tank and thereby agitate the solution and/or object.

The machine may be filled with cleaning solution using an automated filling feature having a pump and reservoir. A liquid level sensor 19 may be positioned in the tank 28 or input tank 18. When signals from that sensor indicate the liquid level is too low, a pump may be caused to move fluid from the reservoir to the tank 28. The cleaning solution may be premixed before being added to the reservoir. In addition, the cleaning solution may need to be mixed after the cleaning solution has been added to the tank 28 in order to prevent separation of the components.

### Examples

Several examples of cleaning solutions were prepared and are disclosed in greater detail below. These cleaning solutions, as disclosed below, may be used to remove unwanted material (e.g., uncured resin or wax) from a surface of a 3D printed object having elastomeric properties.

The 3D printed object may be placed or submerged within the cleaning solution, allowing the solution to dissolve the unwanted support material without affecting the underlying build material (i.e., the elastomeric properties of the underlying build material).

Following submersion and dissolution of the unwanted material, the object is removed from the cleaning solution and subsequently rinsed and dried.

An analysis of the cleaning solution may show that approximately 100% of the unwanted material has been removed while retaining the elastomeric properties of the build material.

The analysis may include one or more mechanical tests or observations to identify whether the elastomeric properties have been retained within the object following the cleaning process. In other words, an example of the 3D printed object may be tested prior to the cleaning, and the same or different example of the 3D printed object may be tested after the cleaning process to identify if the elastomeric properties have been negatively impacted.

In some examples, the mechanical test may include a rubber tensile test (see, e.g., ASTM D412). Additionally, or alternatively, the elastomeric properties may be examined using an elastomer tear test (see, e.g., ASTM D624). In other examples, pre-cleaned and post-cleaned objects may be subjected to a compression set under constant deflection test (see, e.g., ASTM D395).

In yet other examples, the testing may include a swelling test to identify the 3D printed object's ability to withstand the effect of exposure to a liquid. In some examples, this swelling test may be conducted via ASTM D471 test method.

The testing results of the cleaned object may be compared with commercial cleaning solutions such as IPA to demonstrate an improved cleaning performance over the conventional methods/solutions (i.e., the ability to clean and remove unwanted material while retaining elastomeric properties of the 3D printed object).

EXAMPLE 1

| | Percent | | |
|---|---|---|---|
| Chemical | Range | CAS # | Chemical Type |
| 1-Decanol | 1-30% | 112-30-1 | Alcohol |
| 2-Ethyl-1-hexanol | 20-50% | 104-76-7 | Alcohol |
| Isopropyl Myristate | 1-50% | 110-27-0 | Ester |
| Dioctyl Terephthalate | 1-50% | 6422-86-2 | Plasticizer |
| DOW EH-9 | 0.1-5% | 64366-70-7 | Emulsifier |

EXAMPLE 2

| | Percent | | |
|---|---|---|---|
| Chemical | Range | CAS # | Chemical Type |
| 2-Methyl-2,4-pentanediol | 5-50% | 107-41-5 | Diol |
| 1-Decanol | 1-30% | 112-30-1 | Alcohol |
| Isopropyl Myristate | 1-50% | 110-27-0 | Ester |
| Dioctyl Terephthalate | 1-50% | 6422-86-2 | Plasticizer |
| Pluronic L61 | 0.1-5% | 9003-11-6 | Emulsifier |
| Ethyl Carbitol Acetate | 1-20% | 112-15-2 | Glycol Ether Acetate |

EXAMPLE 3

| | Percent | | |
|---|---|---|---|
| Chemical | Range | CAS # | Chemical Type |
| 2-Methyl-2,4-pentanediol | 5-50% | 107-41-5 | Diol |
| Isopropyl Myristate | 1-50% | 110-27-0 | Ester |
| Dioctyl Terephthalate | 1-50% | 6422-86-2 | Plasticizer |
| Pluronic L61 | 0.1-5% | 9003-11-6 | Emulsifier |
| Dipropyl Glycol Monomethyl | 0.1-20% | 88917-22-0 | Glycol Ether |
| Ether Acetate | | | Acetate |

EXAMPLE 4

| | Percent | | |
|---|---|---|---|
| Chemical | Range | CAS # | Chemical Type |
| 2-Methyl-2,4-pentanediol | 5-50% | 107-41-5 | Diol |
| Isopropyl Myristate | 1-50% | 110-27-0 | Ester |
| Hexyl Butyrate | 0.1-20% | 2639-63-6 | Ester |
| Dioctyl Terephthalate | 1-50% | 6422-86-2 | Plasticizer |
| Pluronic L61 | 0.1-5% | 9003-11-6 | Emulsifier |

EXAMPLE 5

| | Percent | | |
|---|---|---|---|
| Chemical | Range | CAS # | Chemical Type |
| 2-Ethyl-1,3-Hexanediol | 20-50% | 94-96-2 | Diol |
| Isopropyl Myristate | 1-50% | 110-27-0 | Ester |
| Heptyl Butyrate | 0.1-20% | 5870-93-9 | Ester |
| Dioctyl Terephthalate | 1-50% | 6422-86-2 | Plasticizer |
| Pluronic L61 | 0.1-5% | 9003-11-6 | Emulsifier |

EXAMPLE 6

| | Percent | | |
|---|---|---|---|
| Chemical | Range | CAS # | Chemical Type |
| 2-Ethyl-1,3-Hexanediol | 20-50% | 94-96-2 | Diol |
| Dipropylene Glycol | 1-20% | 25265-71-8 | Diol |
| Isopropyl Myristate | 1-50% | 110-27-0 | Ester |
| Dioctyl Terephthalate | 1-50% | 6422-86-2 | Plasticizer |
| Pluronic L61 | 0.1-5% | 9003-11-6 | Emulsifier |

EXAMPLE 7

| | Percent | | |
|---|---|---|---|
| Chemical | Range | CAS # | Chemical Type |
| 2-Ethyl-1,3-Hexanediol | 20-50% | 94-96-2 | Diol |
| 2-Methyl-2,4-pentanediol | 1-20% | 107-41-5 | Diol |
| Dipropylene Glycol | 1-20% | 25265-71-8 | Diol |
| Isopropyl Myristate | 1-50% | 110-27-0 | Ester |
| Dioctyl Terephthalate | 1-50% | 6422-86-2 | Plasticizer |
| Pluronic L61 | 0.1-5% | 9003-11-6 | Emulsifier |

EXAMPLE 8

| | Percent | | |
|---|---|---|---|
| Chemical | Range | CAS # | Chemical Type |
| 2-Ethyl-1,3-Hexanediol | 20-50% | 94-96-2 | Diol |
| 2-Methyl-2,4-pentanediol | 1-20% | 107-41-5 | Diol |
| Dipropylene Glycol | 1-20% | 25265-71-8 | Diol |
| Isopropyl Myristate | 1-50% | 110-27-0 | Ester |
| Dioctyl Terephthalate | 1-50% | 6422-86-2 | Plasticizer |
| Pluronic L61 | 0.1-5% | 9003-11-6 | Emulsifier |

EXAMPLE 9

| | Percent | | |
|---|---|---|---|
| Chemical | Range | CAS # | Chemical Type |
| 2-Ethyl-1,3-Hexanediol | 20-50% | 94-96-2 | Diol |
| 2-Methyl-2,4-pentanediol | 1-20% | 107-41-5 | Diol |
| Dipropylene Glycol | 1-20% | 25265-71-8 | Diol |
| Isopropyl Myristate | 1-50% | 110-27-0 | Ester |
| Dioctyl Terephthalate | 1-50% | 6422-86-2 | Plasticizer |
| Pluronic L61 | 0.1-5% | 9003-11-6 | Emulsifier |
| Dipropyl Glycol Monomethyl | 0.1-5% | 88917-22-0 | Glycol Ether |
| Ether Acetate | | | Acetate |

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A cleaning solution for an additive manufactured object, the cleaning solution comprising:
at least one aliphatic alcohol and/or at least one polyol or glycol,
wherein the cleaning solution is configured to remove a support material from the additive manufactured object while retaining an elastomeric property of an underlying build material of the additive manufactured object.

2. The cleaning solution of claim 1, wherein the at least one aliphatic alcohol comprises an aliphatic mono-hydroxy alcohol.

3. The cleaning solution of claim 1, wherein the at least one aliphatic alcohol comprises a long chain aliphatic alcohol having four or more carbon atoms.

4. The cleaning solution of claim 1, wherein the at least one aliphatic alcohol comprises 1-Pentanol, 1-Hexanol, 1-Heptanol, 2-Heptanol, 1-Octanol, 2-Octanol, 3-Octanol, 1-Nonanol, 1-Decanol, 2-Denanol, 3-Decanol, 1-Undecanol, 2-Undecanol, or a combination thereof.

5. The cleaning solution of claim 1, wherein the at least one polyol or glycol comprises at least one aliphatic diol and/or at least one aliphatic triol.

6. The cleaning solution of claim 5, wherein the at least one aliphatic diol and/or the at least one aliphatic triol comprises 2-Ethyl-1-Hexanol, 2-Ethyl-1,3-Hexanediol (also known as Etohexadiol), Propylene Glycol, Dipropylene Glycol, 1,3-Propanediol, 2-Methyl-2,4-pentanediol (also known as Hexylene Glycol), 1,4-Butanediol, 2,2-dimethylpropane-1,3-diol (also known as Neopentyl Glycol), 2-Methyl-1,3-propanediol, 1,4-Butanediol, 1,5-Pentanediol, 1,6-Hexanediol, 1,10-Decanediol, or combinations thereof.

7. The cleaning solution of claim 1, wherein the cleaning solution comprises:
1-100% by weight of the at least one aliphatic alcohol and/or the at least one polyol or glycol; and
0-99% by weight of one or more additional components, such that a total weight percent of the at least one aliphatic alcohol and/or the at least one polyol or glycol and the one or more additional components add up to 100%, ignoring any further additives or impurities present in the cleaning solution,
wherein the one or more additional components comprises a long chain ester, a plasticizer, an emulsifier, a glycol ether acetate, or a combination thereof.

8. The cleaning solution of claim 1, further comprising:
at least one long chain ester having four or more carbon atoms.

9. The cleaning solution of claim 8, wherein the at least one long chain ester comprises Isoamyl Laurate, Isopropyl Myristate, Isopropyl Palmitate, Triacontyl Palmitate, Hexyl Butyrate, Heptyl Butyrate, Ethyl Benzoate, Propyl Benzoate, Butyl Benzoate, Butyl 3-hydroxybutonoate, or a combination thereof.

10. The cleaning solution of claim 1, further comprising:
at least one plasticizer.

11. The cleaning solution of claim 10, wherein the at least one plasticizer comprises Dioctyl Terephthalate, Diethyl Phthalate, Dibutyl Phthalate, Diisobutyl Phthalate, Bis (2-ethylhexyl) Terephthalate, Diisobutyl Terephthalate, Propylene Glycol Dibenzoate, Diethylene Glycol Dibenzoate, Dipropylene Glycol Dibenzoate, or a combination thereof.

12. The cleaning solution of claim 1, further comprising:
at least one emulsifier.

13. The cleaning solution of claim 12, wherein the at least one emulsifier comprises a water-soluble non-ionic triblock copolymer.

14. The cleaning solution of claim 1, further comprising:
at least one glycol ether acetate.

15. The cleaning solution of claim 14, wherein the at least one glycol ether acetate comprises 2-Butoxy Ethanol Acetate, Dipropyl Glycol Monomethyl Ether Acetate, Methyl Carbitol Acetate, Ethyl Carbitol Acetate, Butyl Carbitol Acetate, Propyl Carbitol Acetate, Dipropylene Glycol Butyl Ether Acetate, or a combination thereof.

16. The cleaning solution of claim 1, wherein the cleaning solution comprises:
1-50% by weight of the at least one aliphatic alcohol;
1-50% by weight of the at least one polyol or glycol;
1-50% by weight of at least one long chain ester having four or more carbon atoms;
1-50% by weight of at least one plasticizer;
0.1-10% by weight of at least one emulsifier; and
1-20% by weight of at least one glycol ether acetate, such that a total weight percent of the at least one aliphatic alcohol, the at least one polyol or glycol, the at least one long chain ester, the at least one plasticizer, the at least one emulsifier, and the at least one glycol ether acetate add up to 100%, ignoring any further additives or impurities present in the cleaning solution.

17. The cleaning solution of claim 1, wherein the cleaning solution has a flash point that is greater than 93.3° C. (200° F.).

18. (canceled)

19. A method of removing unwanted support material from a three-dimensional (3D) printed object having an elastomeric property, the method comprising:
providing the 3D printed object having a build material and the unwanted support material;
providing a cleaning solution having at least one aliphatic alcohol and/or at least one polyol or glycol;
submerging the 3D printed object in the cleaning solution; and
removing the 3D printed object from the cleaning solution,
wherein at least a portion of the unwanted support material has been dissolved in the cleaning solution, and
wherein the elastomeric property of the build material of the 3D printed object has been retained following the removing of the 3D printed object from the cleaning solution.

20. The method of claim 19, further comprising:
agitating the object while the 3D printed object is submerged in the cleaning solution; and
rinsing and/or drying the 3D printed object following the removing of the 3D printed object from the cleaning solution.

21.-39. (canceled)

40. The method of claim 19, wherein at least 90% of the elastomeric property of the 3D printed object is retained following dissolution of the unwanted support material in the cleaning solution and the removing of the 3D printed object from the cleaning solution.

41.-42. (canceled)
